(19) United States
(12) Patent Application Publication
(10) Pub. No.: US 2024/0314889 A1
(43) Pub. Date: Sep. 19, 2024

(54) SELF-REGULATING HEATER

(71) Applicant: BOREALIS AG, Vienna (AT)

(72) Inventors: Per-Ola HAGSTRAND, Stenungsund (SE); Niklas THORN, Stenungsund (SE); Anette JOHANSSON, Stenungsund (SE); Mikael KREVERS, Stenungsund (SE)

(21) Appl. No.: 18/266,412

(22) PCT Filed: Dec. 15, 2020
(86) PCT No.: PCT/EP2021/086031

§ 371 Date: Jan. 18, 2024

(30) Foreign Application Priority Data
Dec. 15, 2020 (EP) 20214359.0

(51) Int. Cl. H05B 3/14; H01B 3/44; H05B 3/36

(52) U.S. Cl. CPC H05B 3/146; H01B 3/441; H05B 3/36

(57) ABSTRACT

A flat sheet electrical heater, preferably obtainable by coextrusion, comprising: a plurality of elongate conductors evenly spaced apart from and substantially parallel to each other, said conductors being embedded within and in contact with an electrically semiconductive composition with a positive temperature coefficient comprising a polyethylene, polypropylene or a mixture thereof and a conductive filler wherein the distance between elongate conductors is 20 to 150 mm, wherein said conductors are preferably parallel with the machine direction of the semiconductive composition.

This invention relates to a flat sheet self-regulating heater and to processes for the preparation of such a structure. In particular, the invention relates to the use of colamination to prepare the flat sheet self-regulating heater or, preferably the use of coextrusion to prepare the flat sheet self-regulating heater and hence the ability to prepare these flat sheet self-regulating heaters continuously and hence cheaply.

### BACKGROUND OF INVENTION

Parallel resistance self-regulating heating cables are known. Such cables normally comprise two conductors extending longitudinally along the cable. Typically, the conductors are embedded within a resistive polymeric heating element, the element being extruded continuously along the length of the conductors. The cable thus has a parallel resistance form, with power being applied via the two conductors to the heating element connected in parallel across the two conductors. The heating element usually has a positive temperature coefficient of resistance. Thus as the temperature of the heating element increases, the resistance of the material electrically connected between the conductors increases, thereby reducing power output. Such heating cables, in which the power output varies according to temperature, are said to be self-regulating or self-limiting.

Thus, to avoid overheating and potential destruction of the object, they are self-limiting and require no regulating electronics.

Self-regulation utilises a conversion from electrical to thermal energy by allowing a current to pass through a semiconductive medium with Positive temperature coefficient (PTC) characteristics, which elevates the object temperature above that of its surroundings, until a steady state is reached (self-regulation). A material with a PTC has an electrical resistance that increases with temperature, and is the mechanism behind the self-regulating function. These PTC cables are often used in underfloor heating or wrapped around pipes for e.g. anti-freeze purpose. Cables however, do not offer a significant surface area of heat so it takes a large number of cables to provide underfloor heating for example.

The present inventors therefore sought to provide flat sheet heaters as opposed to cables. Such flat sheets may be rectangular or square in cross section rather than cables.

There are however disclosures of flat sheet heaters in the literature. In WO2014/188190, an electrical heater is described that comprises conductors and a heating element disposed between the conductors wherein the heating element comprises an electrically conductive material distributed within a first electrically insulating material. The insulating material separates the conductor from the electrically conductive material. This complex set up is not however required.

U.S. Pat. No. 6,512,203 describes an apparatus for electrically heating a glass substrate, in which conductors adhere to said surface and a resistive film adheres to said surface.

U.S. Pat. No. 7,250,586 describes a surface heating system for a car seat or the like comprising a support and a heating layer that contains an electrically conductive plastic, which is characterized by the fact that the heating layer is formed by a flexible film and that the support is flexible.

U.S. Pat. No. 4,247,756 describes a heated floor mat in which two inner electrically conductive inner layers sandwich conductors. These conductors are adhered to the inner layers.

U.S. Pat. No. 7,053,344 describes a flexible heater for a fabric. The construction is not one that can be prepared by coextrusion.

EP0731623 describes a PTC cable in which a PVC and conductive filler are present. The cable is surrounded by a microcrystalline siliceous product to improve performance.

U.S. Pat. No. 5,451,747 describes a heat mat with PTC material surrounded by an insulation material. The mat contains two conductors surrounded by a medium density, highly flexible PTC material.

WO2008/133562 describes a heating device with two electrodes within a PTC heat generating material where the PTC material contains electrode interconnection sections of a low resistivity PTC material relative to the rest of the heat generating material. The distance between the electrodes in '562 is 380 mm. Such a large gap leads to problems with heating of the device as the heating process is slow. Moreover, in order to ensure sufficient heat in the device, a high voltage is required, such as that from a mains source. The device in '562 is suitable therefore for a limited number of applications, e.g. under floor heating, but due to the high voltage required, there are inherent safety risks with such a product as accidently drilling into the product could lead to a serious electric shock.

The present inventors have appreciated that simple, flexible and cheap heaters can be prepared where the conductors and the polymer composition in which they are embedded are colaminated or coextruded to form the target material. In the latter embodiment, this means that a continuous sheet can be prepared with a plurality of parallel, equally spaced conductors. Moreover, these flat sheets can be produced with thickness, tailored conductor separation, and different filler levels to allow tailoring of the heat generated. In particular, the conductors are maintained close together, e.g. 2 to 15 cm apart. The resulting device heats very rapidly and lower voltages can be used in the product thus avoiding the risk of electric shock. The device can then be used in a wider variety of applications such as in heated clothing or car seats as battery power or low risk voltages are sufficient to heat the material.

### SUMMARY OF INVENTION

Viewed from one aspect the invention provides a flat sheet electrical heater, preferably obtainable by coextrusion, comprising:
a plurality of elongate conductors evenly spaced apart from and substantially parallel to each other wherein the distance between elongate conductors is 20 to 150 mm,
said conductors being embedded within and in contact with an electrically semiconductive composition with a positive temperature coefficient comprising a polyethylene, polypropylene or a mixture thereof and a conductive filler,
wherein said conductors are preferably parallel with the machine direction of the semiconductive composition.

Viewed from another aspect the invention provides a multilayer flat sheet electrical heater preferably obtainable by coextrusion comprising, in this order,
a first layer comprising an electrically semiconductive composition with a positive temperature coefficient comprising a polyethylene, polypropylene or a mixture thereof and a conductive filler;
a conductor layer comprising a plurality of elongate conductors evenly spaced apart from and substantially parallel to each other wherein the distance between elongate conductors is 20 to 150 mm;
a second layer comprising an electrically semiconductive composition with a positive temperature coefficient comprising a polyethylene, polypropylene or a mixture thereof and a conductive filler such that said conductor layer is sandwiched between and in contact with said first and second layers;
wherein said conductors are preferably parallel with the machine direction of the semiconductive composition.

Viewed from another aspect the invention provides a multilayer flat sheet electrical heater, preferably obtainable by coextrusion, comprising, in this order,
a first layer comprising an electrically semiconductive composition with a positive temperature coefficient comprising a polyethylene, polypropylene or a mixture thereof and a conductive filler;
a conductor layer comprising a plurality of elongate conductors evenly spaced apart from and substantially parallel to each other wherein the distance between elongate conductors is 20 to 150 mm;
a second layer comprising an electrically semiconductive composition with a positive temperature coefficient comprising a polyethylene, polypropylene or a mixture thereof and a conductive filler such that said conductor layer is sandwiched between and in contact with said first and second layers;
wherein said conductors are preferably parallel with the machine direction of the semiconductive composition; and
wherein there is no adhesive between any layers of said heater.

Viewed from another aspect the invention provides a process for the preparation of a multilayer flat sheet electrical heater comprising the steps of (a)
providing and melt mixing in an extruder, a first electrically semiconductive composition comprising a polyethylene, polypropylene or a mixture thereof and a conductive filler,
providing and melt mixing in an extruder, a second electrically semiconductive composition which comprises a polyethylene, polypropylene or a mixture thereof and a conductive filler,
(b) applying on a plurality of evenly spaced apart elongate conductors by coextrusion,
a meltmix of the first electrically semiconductive composition obtained from step (a),
a meltmix of the second electrically semiconductive composition obtained from step (a),
to form a multilayer flat sheet heater having three layers, a core layer comprising a plurality of parallel evenly spaced apart elongate conductors embedded within and in contact with first and second electrically semiconductive composition layers wherein the distance between elongate conductors is 20 to 150 mm;
wherein said elongate conductors are parallel to the machine direction of said semiconductive layers.

Viewed from another aspect the invention provides a process for the preparation of a multilayer flat sheet electrical heater comprising the steps of (a)
providing and melt mixing in an extruder, a first electrically semiconductive composition comprising a polyethylene, polypropylene or a mixture thereof and a conductive filler and extruding said first electrically semiconductive composition to form a first layer,
providing and melt mixing in an extruder, a second electrically semiconductive composition which comprises a polyethylene, polypropylene or a mixture thereof and a conductive filler and extruding said second electrically semiconductive composition to form a second layer,
(b) colaminating said first and second layers with a plurality of evenly spaced apart elongate conductors wherein the distance between elongate conductors is 20 to 150 mm to form a multilayer flat sheet heater having three layers, a core layer comprising a plurality of evenly spaced apart elongate conductors sandwiched between and in contact with first and second electrically semiconductive composition layers;
wherein said elongate conductors are preferably parallel to the machine direction of said semiconductive layers.

### DETAILED DESCRIPTION OF INVENTION

The present invention relates to a flat sheet electrical heater than can be used in a wide variety of objects to provide heat in a safe, cheap and simple manner. The flat sheet electrical heater of the invention uses the principle of positive temperature coefficient (PTC). To avoid overheating and potential destruction of the object, the heater is self-limiting and requires no regulating electronics. In one embodiment therefore, the flat sheet heater of the invention contains no regulating electronics, e.g. a heat cut off to prevent overheating.

The electrically semiconductive composition cannot overheat and requires no overheat protection. The technical solution in this particular invention utilises conversion from electrical to thermal energy by allowing a current to pass through a semiconductive medium with PTC characteristics, which elevates the object temperature above that of its surroundings, until a steady state is reached (self-regulation).

It is preferred if the conductors are parallel with the machine direction of the semiconductive composition. The machine direction is the direction the extruded film moves through the extruder. Films will tend to shrink more in the machine direction than in the transverse direction when subjected to heat so that even in a final article, the orientation can be determined.

The electrically semiconductive composition comprises a polyolefin and a conductive filler (e.g. carbon black). The self-regulating thermal phenomenon occurs due to two parallel antagonistic processes:
a. Poor conduction of electrons through the semiconductive medium generates electrical losses, manifested in heat emission.
b. Thermal expansion of the non-conductive part of the material leads to further decrease of the conductivity by separation of the conductive filler particles.

Once the two processes have equalised, a steady elevated temperature plateau is reached.

The temperature increase in the electrically semiconductive composition is governed mainly by the distance between the parallel conductors, the thickness of the electrically semiconductive composition, the amount of conductive filler present and the applied voltage. Closer conductors increase the temperature at which a steady elevated temperature plateau is reached.

A thicker semiconductive composition in the flat sheet increases the temperature at which a steady elevated temperature plateau is reached.

Increases in conductive filler content increases the temperature at which a steady elevated temperature plateau is reached.

It is preferred that the steady state elevated temperature is no more than 50° C., such as no more than 45° C. The heater should ideally achieve a temperature of at least 30° C.

This gives the product designer freedom to alter the conductivity, the size and shape of the object or the applied voltage in order to reach a pre-determined target temperature.

### Electrically Semiconductive Composition

The electrically semiconductive composition comprises a polyethylene, polypropylene or a mixture thereof. Suitable polyethylenes include high density polyethylene (density of 940 kg/m³ of more), medium density polyethylene (density of 930 to 940 kg/m³), and low density or linear low density polyethylene (density of 910 to 930 kg/m³).

Suitable polypropylenes include homo and copolymers of polypropylene. Suitable comonomers include ethylene.

The use of a polyethylene is preferred. If the heater comprises multiple semiconductive layers, it is preferred if a polyethylene is used in all such layers, preferably the same polyethylene.

It is further preferred if the polyethylene is one prepared in a high temperature autoclave or tubular process such as a LDPE homopolymer or copolymer.

Although the term LDPE is an abbreviation for low density polyethylene, the term is understood not to limit the density range, but covers the LDPE-like high pressure (HP) polyethylenes. The term LDPE describes and distinguishes only the nature of HP polyethylene with typical features, such as different branching architecture, compared to the polyethylene produced in the presence of an olefin polymerisation catalyst.

The LDPE as said polyolefin means a low density homopolymer of ethylene (referred herein as LDPE homopolymer) or a low density copolymer of ethylene with one or more comonomer(s) (referred herein as LDPE copolymer).

It is preferred if the electrically semiconductive composition comprises an LDPE copolymer. The one or more comonomers of LDPE copolymer are preferably selected from the polar comonomer(s), non-polar comonomer(s) or from a mixture of the polar comonomer(s) and non-polar comonomer(s). Moreover, said LDPE homopolymer or LDPE copolymer may optionally be unsaturated.

As a polar comonomer for the LDPE copolymer, comonomer(s) containing carboxyl and/or ester group(s) are used as said polar comonomer. Still more preferably, the polar comonomer(s) of LDPE copolymer is selected from the groups of acrylate(s), methacrylate(s) or acetate(s), or any mixtures thereof.

If present in said LDPE copolymer, the polar comonomer(s) is preferably selected from the group of alkyl acrylates, alkyl methacrylates or vinyl acetate, or a mixture thereof.

Further preferably, said polar comonomers are selected from C₁-to C₆-alkyl acrylates, C₁-to C₆-alkyl methacrylates or vinyl acetate. Still more preferably, said LDPE copolymer is a copolymer of ethylene with C₁-to C₄-alkyl acrylate, such as methyl, ethyl, propyl or butyl acrylate, or vinyl acetate, or any mixture thereof. The use of ethylene methyl acrylate (EMA), ethylene ethyl acrylate (EEA), ethylene butyl acrylate (EBA) or ethylene vinyl acetate (EVA) is preferred.

As the non-polar comonomer(s) for the LDPE copolymer preferred options are polyunsaturated comonomers comprising C and H atoms only. In a preferred embodiment, the polyunsaturated comonomer consists of a straight carbon chain with at least 8 carbon atoms and at least 4 carbon atoms between the non-conjugated double bonds, of which at least one is terminal.

A preferred diene compound is 1,7-octadiene, 1,9-decadiene, 1,11-dodecadiene, 1,13-tetradecadiene, or mixtures thereof. Furthermore, dienes like 7-methyl-1,6-octadiene, 9-methyl-1,8-decadiene, or mixtures thereof can be mentioned.

If the LDPE polymer is a copolymer, it preferably comprises 0.001 to 40 wt.-%, more preferably 0.05 to 40 wt.-%, still more preferably 1 to 30 wt %%, of one or more comonomer(s). Where there is a polar comonomer, the comonomer content is preferably 5 to 30 wt %, such as 7.5 to 20 wt %.

The polyolefin may optionally be unsaturated, e.g. the LDPE polymer may comprise carbon-carbon double bonds. The term “unsaturated” means herein that the polyolefin contains carbon-carbon double bonds/1000 carbon atoms in a total amount of at least 0.2/1000 carbon atoms, such as at least 0.4/1000 carbon atoms.

The polyolefin can be unimodal or multimodal, e.g. bimodal.

Preferably, the polyolefin has a melt flow rate MFR2.16/190° C. of 0.1 to 50 g/10 min, more preferably 0.3 to 20 g/10 min, even more preferably 1.0 to 15 g/10 min, and most preferably 2.0 to 10 g/10 min.

Any LDPE homopolymer or copolymer may have a density of 905 to 935 kg/m³, such as 910 to 925 kg/m³.

The polyolefin can be produced by any conventional polymerisation process. Preferably, it is an LDPE and is produced by radical polymerisation, such as high pressure radical polymerisation. High pressure polymerisation can be effected in a tubular reactor or an autoclave reactor. Preferably, it is a tubular reactor. In general, the pressure can be within the range of 1200-3500 bars and the temperature can be within the range of 150° C.-350° C. Further details about high pressure radical polymerisation are given in WO93/08222, which is herewith incorporated by reference. The polymers of the semiconductive composition are well known and are commercially available.

The electrically semiconductive composition may comprise at least 50 wt % of the polyethylene, polypropylene or a mixture thereof, such as at least 60 wt %. Any layer in which the electrically semiconductive composition is present may consist of the electrically semiconductive composition. Any layer in which the electrically semiconductive composition is present may comprise at least 50 wt % of the polyethylene, polypropylene or a mixture thereof, such as at least 60 wt %. The polyethylene and/or polypropylene will form the balance of the electrically semiconductive composition once all other components are determined.

### Conductive Filler

According to the present invention, the electrically semiconductive composition further comprises a conductive filler such as carbon black.

Suitable conductive fillers include graphite, graphene, carbon fibres, carbon nanotubes, metal powders, metal strands or carbon black. The use of carbon black is preferred.

The semiconductive properties result from the conductive filler added. Thus, the amount of conductive filler is at least such that a semiconducting composition is obtained. Depending on the desired use and conductivity of the composition, the amount of conductive filler can vary. Preferably, the electrically semiconductive composition comprises 5-50 wt % conductive filler. In other preferred embodiments, the amount of conductive filler is 5-48 wt.-%, 10-45 wt %, 20-45 wt %, 25-45 wt % or 30-41 wt %, based on the weight of the electrically semiconductive composition.

Any carbon black can be used which is electrically conductive. Examples of suitable carbon blacks include furnace blacks, channel blacks, gas blacks, lamp blacks, thermal blacks and acetylene blacks. Additionally, graphitised furnace blacks (as produced by Imerys) and high structure blacks (known as Ketjenblacks produced by Nouryon) may also be used. Mixtures may also be used. Where a blend of carbon blacks is used then this percentage refers to the sum of the carbon blacks present.

The carbon black may have a nitrogen surface area (BET) of 5 to 1500 m²/g, for example of 10 to 300 m²/g, e.g. of 30 to 200 m²/g, when determined according to ASTM D3037-93. Further, the carbon black may have one or more of the following properties:
i) a primary particle size of at least 5 nm which is defined as the number average particle diameter according to ASTM D3849-95a,
ii) iodine adsorption number (IAN) of at least 10 mg/g, for example 10 to 300 mg/g, e.g. 30 to 200 mg/g, when determined according to ASTM D-1510; and/or
iii) DBP (dibutyl phthalate) absorption number (=oil absorption number) of at least 30 cm³/100 g, for example 60 to 300 cm³/100 g, e.g. 70 to 250 cm³/100 g, for example 80 to 200 cm³/100 g, e.g. 90 to 180 cm³/100 g, when measured according to ASTM D 2414.
   Furthermore, the carbon black may have one or more of the following properties:
   a) a primary particle size of at least 15 nm which is defined as the number average particle diameter according ASTM D3849-95a;
   b) iodine number of at least 30 mg/g according to ASTM D1510;
   c) oil absorption number of at least 30 ml/100 g which is measured according to ASTM D2414.

Furnace carbon blacks are preferred. This is a generally acknowledged term for the well-known carbon black type that is produced continuously in a furnace-type reactor. As examples of carbon blacks, the preparation process thereof and the reactors, reference can be made to i.a. EP-A-0629222 of Cabot, U.S. Pat. Nos. 4,391,789, 3,922,335 and 3,401,020. As an example of commercial furnace carbon black grades described in ASTM D 1765-98b i.a. N351, N293 and N550, can be mentioned.

### Other Components

The composition may be crosslinked using peroxide or silane moisture curing systems. Crosslinking may also be effected using irradiation to avoid the need for a crosslinking agent.

Preferably, crosslinking is avoided and the resulting sheet is a more recyclable product. The semiconductive composition of the invention is preferably not crosslinked.

### Antioxidant

The semiconductive composition may contain an antioxidant. As antioxidant, sterically hindered or semi-hindered phenols, aromatic amines, aliphatic sterically hindered amines, organic phosphates, thio compounds, polymerized 2,2,4-trimethyl-1,2-dihydroquinoline and mixtures thereof, can be mentioned.

More preferred, the antioxidant is selected from the group of 4,4′-bis(1,1′dimethylbenzyl)diphenylamine, para-oriented styrenated diphenylamines, 4,4′-thiobis (2-tert. butyl-5-methylphenol), polymerized 2,2,4-trimethyl-1,2-dihydroquinoline, 4-(1-methyl-1-phenylethyl)N-[4-(1-methyl-1-phenylethyl)phenyl] aniline or derivatives thereof.

More preferred, the antioxidant is selected from the group (but not limited to) of 4,4′-bis(1,1′dimethylbenzyl)diphenylamine, para-oriented styrenated diphenylamines, 4,4′-thiobis (2-tert. butyl-5-methylphenol), 2,2′-thiobis(6-t-butyl-4-methylphenol), distearylthiodipropionate, 2,2′-thio-diethyl-bis-(3-(3,5-di-tertbutyl-4-hydroxyphenyl)propionate, polymerized 2,2,4-trimethyl-1,2-dihydroquinoline, or derivatives thereof. Of course, not only one of the above-described antioxidants may be used but also any mixture thereof.

The amount of antioxidant, optionally a mixture of two or more antioxidants, can range from 0.005 to 2.5 wt-%, such as 0.01 to 2.5 wt-%, preferably 0.01 to 2.0 wt-%, more preferably 0.03 to 2.0 wt-%, especially 0.03 to 1.5 wt-%, more especially 0.05 to 1.5 wt %, or 0.1 to 1.5 wt % based on the weight of the semiconductive composition.

The semiconductive composition may comprise further additives. As possible additives stabilisers, processing aids, flame retardant additives, acid scavengers, inorganic fillers, voltage stabilizers, or mixtures thereof can be mentioned.

Preferably, the electrically semiconductive composition has a volume resistivity, measured at 90° C., of less than 500000 Ohm·cm, more preferably less than 100000 Ohm·cm, even more preferably less than 50000 Ohm·cm.

### Conductors

The heater of the invention comprises a plurality of conductors. The term plurality is used herein to imply at least 2, such as at least 4 conductors. Ideally, the sheet of the invention comprises an even number of conductors. Ideally, in use, the conductors preferably have alternate polarity.

The elongate conductors can be made from any suitable conductive metal, typically copper or aluminium. The conductor may be in the form of a tape, foil or wire. Conductors may have a diameter or thickness of 0.05 to 2.0 mm. Conductors may have a width of 0.5 to 15 mm, such as 1.0 to 10 mm. The length of the elongate conductor is governed by the size of the flat sheet. The elongate conductor should pass through the majority, such as the whole, of the sheet. Each conductor may be provided with an electrode to allow the plurality of conductors to be inter connected and to allow the application of an external power source to create a circuit and hence heat. The conductors may be designed to be directly solderable for ease of installation.

The flat sheet heater may comprise a minimum of 4 separate conductors but it may contain many more conductors. The conductors are spaced apart from each and hence do not touch. The conductors are substantially parallel to each other. All conductors should be evenly spaced from each other. By evenly spaced means that the distant between adjacent conductors is always the same. The conductors are preferably linear and are preferably oriented in the machine direction relative to the semiconductive composition. In theory however the conductors might be curved (SS shaped for example) such that they remain equidistant from each other at all times. We regard this as being “parallel”.

The elongate conductors are spaced by 20 to 150 mm. In one embodiment, the gap between the conductors is 20 to 100 mm, such as 30 to 90 mm, preferably 40 to 80 mm. These gaps between the conductors are important to ensure that heat is generated rapidly within the PTC material. If the conductors are too far apart then the PTC material takes a long time to warm up. Having the conductors closer together also allows the use of a lower voltage in the device. This is important as the heater can generate heat without the risk of an electric shock. Where higher voltages are used, such as where the heater is plugged into mains current, there is a larger risk of an electric shock. Where the gaps between conductors are reduced, sufficient heat can be generated from, for example, a battery. In one embodiment therefore the heater is supplied with direct current. This forms a further aspect of the invention. It is particularly preferred if the heater is supplied with direct current.

The conductors are in direct contact with the electrically semiconductive composition. There should not therefore be a layer separating the electrically semiconductive composition from the conductor. The conductors must also be embedded within the electrically semiconductive composition, i.e. they should not sit on top or underneath the electrically semiconductive composition but are encompassed by it. This is achieved when the conductors are coextruded with the electrically semi-conductive composition. It might also be achieved by sandwiching the conductors between two layers of electrically semiconductive composition.

As the conductors can be regarded as embedded within the electrically semiconductive composition we avoid hot spots or localised overheating in the material.

The conductors preferably run parallel to the machine direction of the semiconductive composition.

It will be appreciated that the conductor layer is not continuous and is formed from a plurality of discreet conductors which are parallel and evenly spaced. The gaps between these discreet conductors are filled by the electrically semiconductive composition, e.g. as shown in FIG. 1, during the colamination or coextrusion process.

### Production

It is possible for the claimed flat sheet heater to be prepared by colamination. In such a process, two electrically semiconductive layers can be prepared, e.g. via extrusion. These may be allowed to cool before colamination occurs. The layers may be the same or different. Ideally they are the same. These layers are preferably the same thickness.

These layers can then be used to sandwich a layer of the conductors. One layer is therefore placed above and one layer placed below the conductors and the ensemble compressed together. The gaps between the conductors are therefore filled by the electrically semiconductive layers. It will be appreciated that the conductor layer is often very thin compared to the electrically semiconductive layers.

It is possible to heat one surface of one or both electrically semiconductive layers before colamination such that when colaminated together, the electrically semiconductive layers adhere to the conductors and adhere to the other electrically semiconductive layer without the use of a separate adhesive. In this way, the conductor layer becomes embedded within an electrically semiconductive composition.

In a particularly preferred embodiment, lamination between the layers only occurs close to the conductors. For example, a strip either side of each conductor may be melted to allow the two layers to adhere to each other. For example, a strip 5 mm either side of the location of the conductor in the flat sheet heater may be melted in one or both of the layers to allow the layers to be adhered. The width of the melted strip might be 5 to 20 mm either side of the location of the conductor, such as 10 to 20 mm. The width of the melted strip may be adjusted depending on the gap between the conductors.

The area of the sheet where the conductors will reside may also be melted to allow the conductors to stick to the flat sheet heater during the lamination process. The overall thickness of the strip to be melted may therefore take into account the diameter of the conductor itself. Thus, for a 2 mm diameter conductor with 5 mm either side of the conductor melted for lamination, the entire width of the strip melted is 12 mm.

Outside of these melted strips, the two layers are not laminated together so are able to move independently. This provides enhanced flexibility to the flat sheet heater which is important for applications such as heated clothing where the heater must be flexible.

FIG. 5 illustrates the proposed process in which the conductors are placed on one layer of the flat sheet heater and a strip either side of the conductors is melted to allow the second sheet to adhere to the first sheet. Conveniently, the conductor is adhered to the sheets during the lamination process so the area under the location of the conductors is also melted.

It will be appreciated that the melted strip could be on one layer or both layers of the laminate.

Viewed from another aspect the invention provides a process for the preparation of a multilayer flat sheet electrical heater comprising the steps of (a)
providing and melt mixing in an extruder, a first electrically semiconductive composition comprising a polyethylene, polypropylene or a mixture thereof and a conductive filler and extruding said first electrically semiconductive composition to form a first layer,
providing and melt mixing in an extruder, a second electrically semiconductive composition which comprises a polyethylene, polypropylene or a mixture thereof and a conductive filler and extruding said second electrically semiconductive composition to form a second layer,
(b) colaminating said first and second layers with a plurality of evenly spaced apart elongate conductors wherein the distance between elongate conductors is 20 to 150 mm to form a multilayer flat sheet heater having three layers, a core layer comprising a plurality of evenly spaced apart elongate conductors sandwiched between and in contact with first and second electrically semiconductive composition layers;
wherein the first and second layers are adhered only via a strip extending 50 to 200 cm either side of each conductor.

A preferred key aspect of the invention is that the claimed flat sheet heater can be prepared using coextrusion. The heater of the invention is preferably not therefore a typical laminate where the various layers are prepared separately and laminated together, perhaps using an adhesive. We do not require adhesive in our product to form the required heater.

The heater of the invention can therefore be prepared continuously.

Importantly, the semiconductive composition can be extruded onto the conductors and hence these are embedded within the semiconductive composition during the extrusion process rather than separately adhered to the semiconductive composition. The semiconductive composition that forms the layer above and below the plurality of conductors can therefore be extruded continuously onto those conductors.

The process described herein is therefore one that can be operated continuously maximising the value of the formed product. The heater of the invention is cheap. It is also thin and flexible.

It is preferred therefore if two semi-conductive layers are coextruded to encompass the central conductors, as shown in FIG. 3.

In the preferred embodiment of the invention the process comprises the steps of (a)
providing and melt mixing in an extruder, a first electrically semiconductive composition comprising a polyethylene, polypropylene or a mixture thereof and a conductive filler,
providing and melt mixing in an extruder, a second electrically semiconductive composition which comprises a polyethylene, polypropylene or a mixture thereof and a conductive filler,
(b) applying on a plurality of evenly spaced apart elongate conductors by coextrusion,
a meltmix of the first electrically semiconductive composition obtained from step (a),
a meltmix of the second electrically semiconductive composition obtained from step (a),
to form a flat sheet heater having three layers, a core layer comprising a plurality of parallel evenly spaced apart elongate conductors embedded within and in contact with said first and second electrically layers comprising said electrically semiconductive composition;
wherein said elongate conductors are parallel to the machine direction of said semiconductive layers.

This process can be readily adapted to include further layers above or below the semiconductive layers.

In one embodiment, crosslinking conditions can then be applied to cause a crosslinking reaction.

Melt mixing means mixing above the melting point of at least the major polymer component(s) of the mixture and is typically carried out in a temperature of at least 10-15° C. above the melting or softening point of polymer component(s).

The term coextrusion means herein that two or more layers are extruded in the same extrusion step. The term coextrusion means that all or part of the layer(s) are formed simultaneously using one or more extrusion heads. For instance triple extrusion can be used for forming three layers.

The heater of the invention can therefore be seen as a multilayer flat sheet heater comprising, in this order, a first layer comprising an electrically semiconductive composition with a positive temperature coefficient comprising a polyethylene or polypropylene and a conductive filler;
a conductor layer comprising a plurality of spaced apart conductors;
a second layer comprising an electrically semiconductive composition with a positive temperature coefficient comprising a polyethylene, polypropylene or a mixture thereof and a conductive filler such that said conductor layer is embedded within and in contact with said first and second layers.

The electrodes are embedded within the semiconductive layers and run parallel to the machine direction of the polymer layers. The two semiconductive compositions can be the same or different, preferably the same.

Once the coextrusion has been effected, the formed flat sheet can be crosslinked if required by subjecting the material to well-known crosslinking conditions.

### Flat Sheet Heater

The heater is in the form of a flat sheet which is flexible, lightweight and cheap. The heater may be provided with one or more additional layers to protect the semiconductive composition from damage. For example, an aesthetic top layer can be textile fabric, non-woven or solid sheet (rubber, plastic, paper, wood, metal, etc.). Optionally, no top layer(s) are used. The top layer may be extrudable, e.g. a polyolefin layer.

In one embodiment the heater is provided with an insulation layer or heat reflective layer at the base of the heater. Such an insulation layer may be electrically insulating, thermally insulating or both. Such a layer increases the effectiveness of the heater. Such a layer may comprise a polyolefin such as a polyethylene, especially an LDPE, e.g. an LDPE homopolymer. Preferred insulation layers use LDPE as the only polymer component. Such a layer is preferably one that can be coextruded although lamination of this layer is also an option.

It is most preferred that any additional layers are also coextruded. In one embodiment, the heater comprises a five layer construction with conductors forming the central layer embedded within two electrically semiconductive layers which in turn are protected with further layers. This is an ABCDE type construction. The layers A/E and the layers B/D need not be the same.

It is preferred if the electrically semiconductive layers have substantially the same thickness.

Preferably, an insulating and/or heat reflective layer can be positioned underneath the semi-conductive composition(s). This layer can reduce heat losses. It may also provide mechanical protection of the semi-conductive layer(s) and strength to the flat sheet.

In a particular preferred embodiment, the use of an additional insulation layer is avoided. This makes the heater even cheaper. As the conductors are close together in the claimed invention and as that allows a reduction in the voltage required to power the heater, the use of an insulation layer is not required. Where higher voltages are used, the insulation layer serves to protection the PTC material and serves to protect a user from possible shock. In our device, the use of such a layer is not required. The heater of the invention may therefore consist of the required conductor layer and semiconductive layers.

In use current is applied to the heater via the conductors to generate heat. Typically voltages are 10 to 70 v, such as 10 to 55 v, preferably 10 to 40 v, such as 12 to 30 v. The application of the power to the flat sheet heater leads to almost instant heat. There is no risk of electrocution as the voltage used does not need to be high. The heater could be powered via battery or direct from the mains with a suitable adapter.

The heater itself may reach its maximum temperature in less than 300 seconds from the application of power. Preferably, the heater will reach maximum temperature between 50 and 250 seconds after power is applied. The heater therefore reaches working temperature incredibly rapidly.

As previously noted therefore, the steady state elevated temperature is preferably no more than 50° C., such as no more than 45° C. The heater should ideally achieve a temperature of at least 30° C.

It will be appreciated that the steady state elevated temperature is no more than 50° C., such as no more than 45° C. The heater should ideally achieve a temperature of at least 30° C.

The heater itself is preferably up to 20 mm in thickness, preferably up to 10 mm, such as 0.25 to 5 mm. The key semiconductive composition layers may be 100 to 900 μm in thickness, such as 125 to 800 μm.

The width of the heater can be adjusted readily to any possible use. The width may be a function of the coextrusion apparatus and sheets from 5 cm to 5 metres can be produced readily.

As previously discussed, the heating power of the flat sheet heater can be controlled through the thickness of the sheet, separation of the conductors, conductive filler content and applied voltage. Moving the conductors closer together increases the wattage and hence the heat generated. The relationship can be expressed as power=[voltage]²/resistance.

As the semiconductive composition layers are thin, the flat sheet heater of the invention is very flexible making it ideal for use in environments where flexibility is essential. Such environments include heated clothing or heated car seats where the flat sheet heater needs to flex to operate efficiently.

Thicker flat sheets tend to increase the power output.

The simplicity of the claimed flat sheet heater is also important as that makes it very cheap to manufacture. The entire device can be manufactured using coextrusion. There are no laminations steps, no adhesive etc. required.

### Applications

The flat sheet heater of the invention can be utilised in many fields. Applications of the technology described herein are therefore widespread.

We often provide thermal comfort in winter by heating the entire volume of air in a room or building. In earlier times, our ancestor's concept of heating was more localized: heating people, not places. They used radiant heat sources that warmed only certain parts of a room, creating micro-climates of comfort. These people countered the large temperature differences with insulating furniture, such as hooded chairs and folding screens, and they made use of additional, personal heating sources that warmed specific body parts. It would make a lot of sense to restore this old way of warming, especially since modern technology has made it so much more practical, safe and efficient.

The heater of the invention may therefore be employed within an item of furniture such as a screen, chair or sofa.

In one embodiment the heater of the invention might be used in a heated garment. Heated garments available today have small wires (often made of brittle carbon fibres) built into them. They heat up when a low voltage electric current is passed through. There are two main types of heated clothing, battery powered or powered by a vehicle (e.g. heated gloves on a motorcycle). The heaters of the invention are ideally suited for use in both these applications.

The heater may also be used in a blanket. A major concern with electric heating blankets on the market today is fire risk. These blankets tend to overheat. Using the heater of the present invention that risk is eliminated.

Radiators are large, immobile and often unattractive. In many parts of the world, radiators are hidden behind more aesthetically pleasing covers of various designs. These covers may also reduce noise or protect against the touching of radiators that get excessively hot. But hiding the radiator is not efficient because adding a radiator cover slows the movement of heat out of the radiator and into the room. The rate of heat loss out through the building's exterior wall is likely to be increased.

The sheets of the invention can replace radiators or be used in walls, under floors, in ceilings as heaters. The heater could even be included within a carpet or rug or other floor covering

Electric cars generate next to no heat as opposed to conventional passenger vehicles, which produce more than enough engine heat to heat the interior. An additional electric heater is therefore required in an electric vehicle to heat the interior.

This heater is supplied with power by the same battery that provides the engine with energy. This can reduce the maximum possible drive distance by a considerable amount.

Thus, there is a need for heating e-vehicles as efficiently as possible. The present invention might be used to heat inner contact surfaces such as steering wheel, armrest, door panels, seats within the vehicle. More efficient heating can be envisaged compared to heating the entire inner volume of the car, especially for short journeys.

The heater of the invention could be used to prevent ice or snow build up on a critical surface such as a solar panel. Heaters might therefore have utility in deicing operations. Other surfaces might be wing mirrors.

The heaters are also flexible and might be wrapped around pipes to prevent liquid freezing therein. Heaters can furthermore be used to keep fluids heated e.g. in swimming pools or liquid containers.

### BRIEF DESCRIPTION OF THE FIGURES

FIG. 1 is a theoretical image of a flat sheet heater of the invention. Semiconductor layers A and B sandwich conductors that are evenly distributed in the sheet. Top and bottom layers sandwich the semiconductive layer. The top layer is aesthetic and bottom layer acts as an insulation or heat reflective layer. In some embodiments, the top and/or bottom layers can be removed. A particularly preferred structure is therefore simply the semiconductive layers A and B with the conductor layer. It is further preferred if the semiconductive layer material is the same in both layers A and B and that the thickness of layers A and B is the same.

In FIG. 2 is a cross section of a flat sheet heater of the invention of FIG. 1 seen from above. A plurality of conductors are embedded within the electrical semiconductive layers. These layers are formed via colamination or coextrusion of the semiconductive composition and the conductor. They have alternate polarity.

FIG. 3 is a schematic illustration of the manufacturing process. The set up in FIG. 3 leads to a 5 layer type construction with aesthetic top layer, 1^{st} semicon layer, conductor layer, 2^{nd} semicon layer and insulation layer. The conductors are dispensed as metal electrode tapes to form the central layer in the coextruded or colaminated sheet. Semiconductor compositions are coextruded or colaminated to form layers on either side of the conductors with top and bottom layers being coextruded or colaminated on the upper and lower surfaces of the semiconductive layers. In case of coextrusion, the relevant polymers are melted and coextruded through a die to nip rollers before passing over further rollers to form the multilayer flat sheet. The nip rollers can be heated and/or coated to prevent adhesion of the polymer melt to the roller.

The lowest layer typically meets the heated roll for a quarter of a turn with the other layers in direct contact with the layer below. Most heat hits the lower layer. At the start of the turn, both rolls are separated by, for example a distance of 0.3 mm. The three layers then align to the second roll for a half turn before passing over a third roll for a quarter turn.

Current can then be applied by connecting the conductors to a power supply.

FIG. 4 shows a test specimen (LE7710) (thickness 0.8 mm, 52 mm wide) equipped with aluminium electrodes (1.7 mm wide and 0.3 mm thick) at 40 mm separation.

FIG. 5 shows a cross section of one layer of a flat sheet heater in which a strip either side of the conductor is melted to allow colamination to a second sheet.

FIGS. 6 to 15 show heat vs time curves for various flat sheet heaters of the invention using differing layer thicknesses, applied voltages and conductor separation. Table 2 summarises the data.

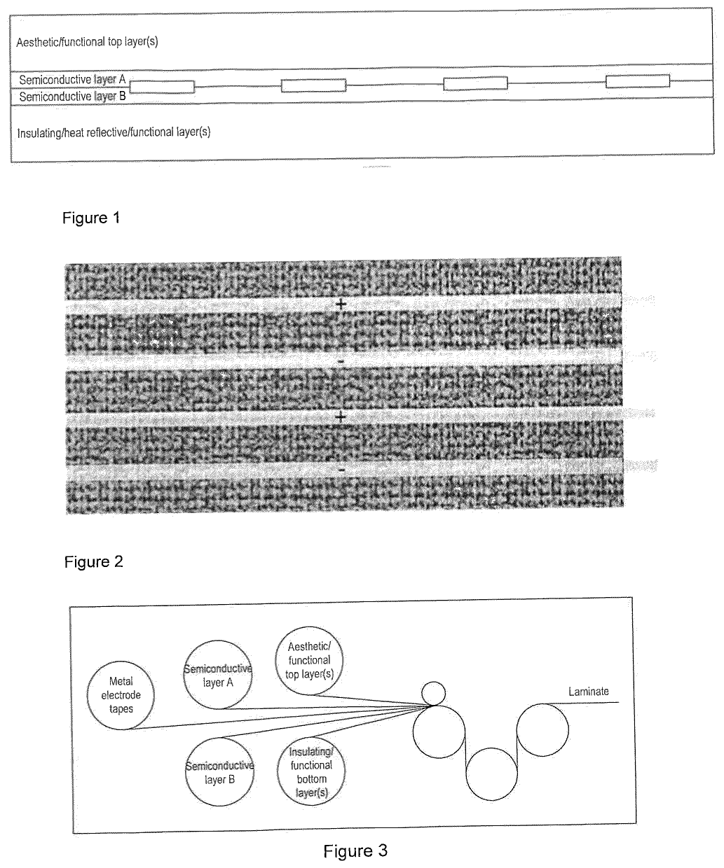

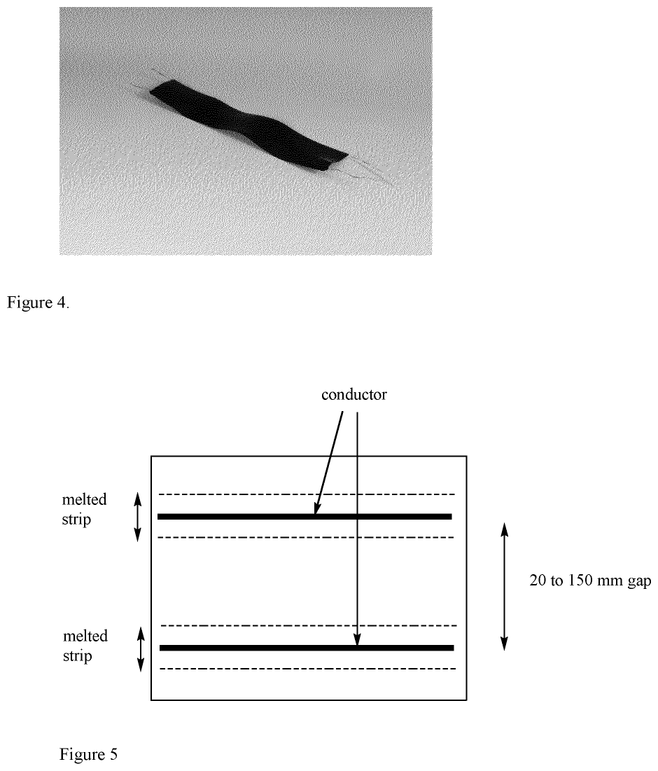

### EXAMPLES

### Manufacturing Processes

Self-regulating heating laminates have been made using continuous processes.

LE7710 is a semiconductive composition containing about 60 wt % of a copolymer of ethylene and butyl acrylate and about 39 wt % of carbon black. It is commercially available from Borealis AG. This is used in the examples which follow.

### Example 1—Continuous Process Description

A 3-layer flat sheet (semicon film/electrodes/semicon film) was produced by continuously feeding and sandwiching the 3 layers simultaneously between two heated rotating metal rollers. In order to prevent semicon films sticking to the metal rollers, these were covered with 0.05 mm thick Teflon film.

A Collin W 150 AP two roll mill machine was used. Two rolls 400 mm wide, placed besides each other.
Settings were as follows:
Temperature of metal rolls: 96° C.
Rotating speed of metal rolls: 0.2 rpm
Gap between metal rolls: 0.3 mm
   The flat sheet produced had an overall thickness of 0.4 mm. The electrode separation distances were approximately 30 mm.
   The three layers were feed from one side of the two roll mill. The lower layer meets the heated roll for a quarter of a turn with the other layers in direct contact. Most heat hits the lower layer. At that quarter turn both rolls meets (with a distance of 0.3 mm). Now the three layers align to the second roll for a half a turn. The take up part of a Collin Teach-Line CR 72T was used on a spool 350 mm wide.
   The flat sheet made according to Example 1 was subsequently connected to a DC voltage source (23.9 V) which generated a temperature rise according to Table 1 below.

TABLE 1

| Time | Current | Temperature 1 | Temperature 2 | Electric Power |
|---|---|---|---|---|
| [s] | [A] | [° C.] | [° C.] | [W] |
| 0 | 1.9 | 23.3 | 23.8 | 43.7 |
| 10 | 1.3 | 25.6 | 25.9 | 29.9 |
| 20 | 1.1 | 29.9 | 29.3 | 25.3 |
| 30 | 0.97 | 33.0 | 31.1 | 22.3 |
| 40 | 0.91 | 35.3 | 32.4 | 20.9 |
| 50 | 0.88 | 37.2 | 33.1 | 20.2 |
| 60 | 0.86 | 38.6 | 33.5 | 19.8 |
| 80 | 0.82 | 40.5 | 34.1 | 18.9 |
| 100 | 0.78 | 41.1 | 34.1 | 17.9 |

Electrode distance where Temp. 1 was measured: ˜30 mm
Electrode distance where Temp. 2 was measured: ˜30 mm
Length of laminate: 700 mm

### Example 2

Following the protocols in example 1, further flat sheet heaters were prepared with varying distances between the conductors and different numbers of conductors. The heating profile of these flat sheet heaters was then established using differing applied voltages.

### Runs 1 to 4: 250 μm Layers, 2 Conductors.

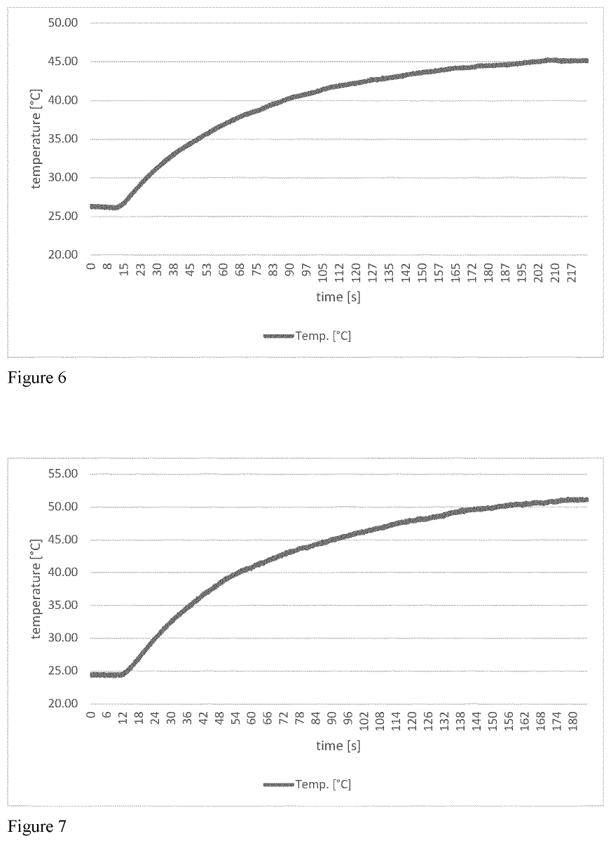

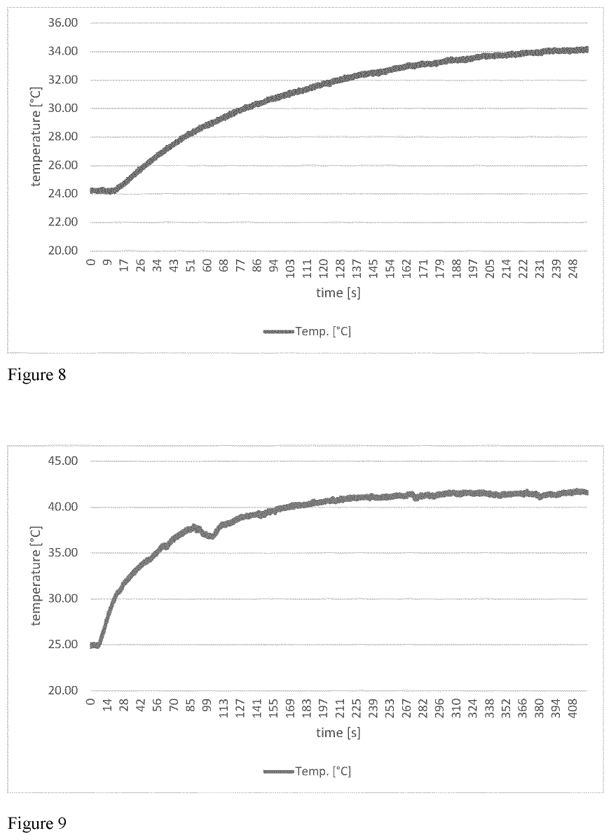

Run 1: Layers of 250 μm sandwich 2 conductors to give an overall thickness of 0.5 mm. The conductors are 30 mm apart with an applied voltage of 12 v. FIG. 6 shows the heating profile with time for this heater. The heater takes approximately 200 seconds to reach a maximum heat of around 45° C.
Run 2: Layers of 250 μm sandwich 2 conductors to give an overall thickness of 0.5 mm. The conductors are 60 mm apart with an applied voltage of 24 v. FIG. 7 shows the heating profile with time for this heater. The heater takes approximately 200 seconds to reach a maximum heat of around 45° C.
Run 3: Layers of 250 μm sandwich 2 conductors to give an overall thickness of 0.250 mm. The conductors are 60 mm apart with an applied voltage of 12 v. FIG. 8 shows the heating profile with time for this heater. The heater takes approximately 200 seconds to reach a maximum heat of around 34° C.
Run 4: Layers of 250 μm sandwich 2 conductors to give an overall thickness of 0.250 mm. The conductors are 30 mm apart with an applied voltage of 24 v. FIG. 9 shows the heating profile with time for this heater. The heater takes approximately 200 seconds to reach a maximum heat of around 42° C.

### Runs 5-6—125 μm Layers, 2 Conductors.

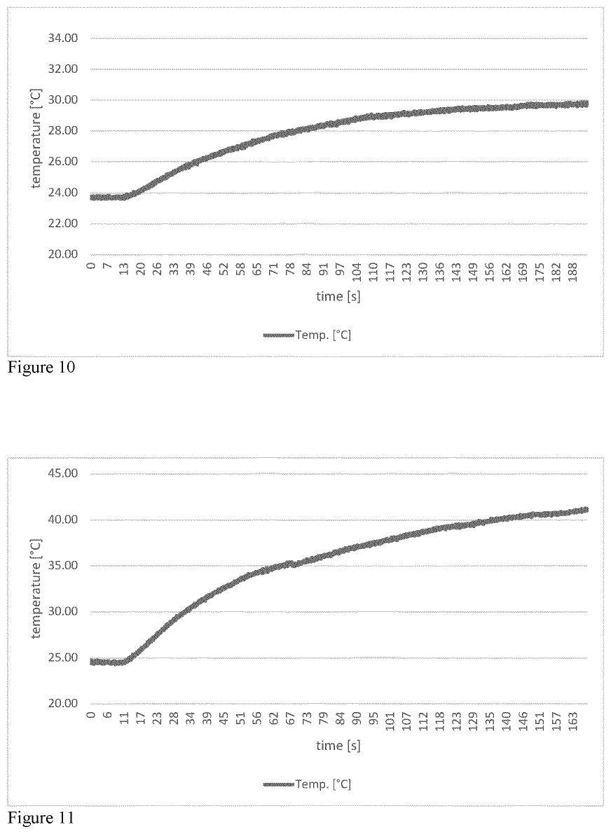

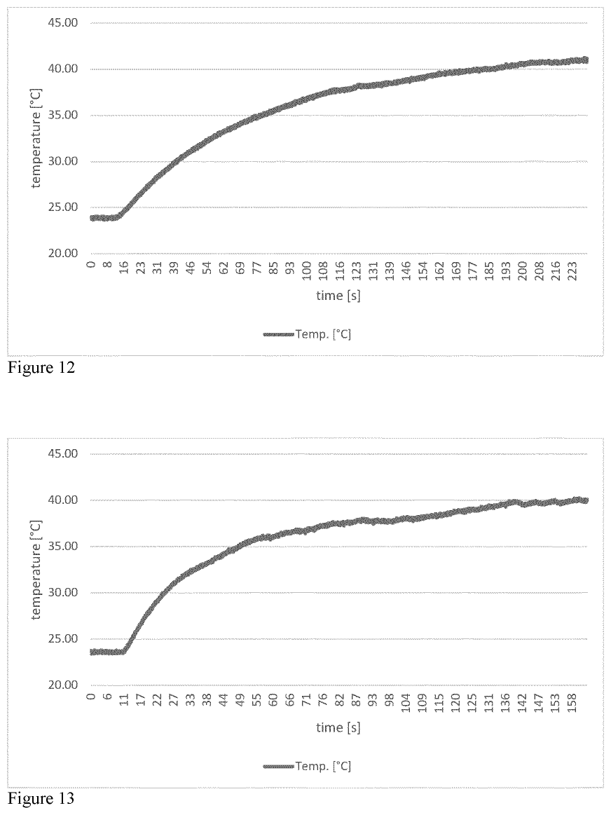

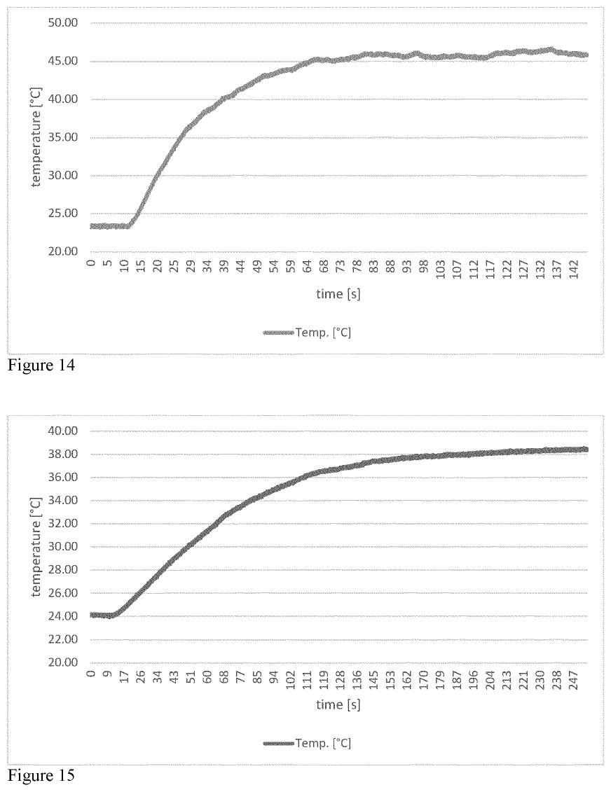

Run 5: Layers of 125 μm sandwich 2 conductors to give an overall thickness of 0.250 mm. The conductors are 30 mm apart with an applied voltage of 12 v. FIG. 10 shows the heating profile with time for this heater. The heater takes approximately 150 seconds to reach a maximum heat of around 30° C.
Run 6: Layers of 125 μm sandwich 2 conductors to give an overall thickness of 0.250 mm. The conductors are 60 mm apart with an applied voltage of 24 v. FIG. 11 shows the heating profile with time for this heater. The heater takes approximately 150 seconds to reach a maximum heat of around 40° C.
   Runs 7 to 8—125 μm Layers with 4 Conductors.

Where 4 conductors are present there are three 3 heating zones between the conductors-reported temperature increases are an average of all zones.
Run 7: Layers of 125 μm sandwich 4 conductors to give an overall thickness of 0.250 mm. The conductors are 53 mm apart with an applied voltage of 24 v. FIG. 12 shows the heating profile with time for this heater. The heater takes approximately 200 seconds to reach a maximum heat of around 42° C.
Run 8: Layers of 125 μm sandwich 4 conductors to give an overall thickness of 0.250 mm. The conductors are 30 mm apart with an applied voltage of 24 v. FIG. 13 shows the heating profile with time for this heater. The heater takes approximately 150 seconds to reach a maximum heat of around 40° C.
   Runs 9 and 10—250 μm layers with 4 conductors
Run 9: Layers of 250 μm sandwich 4 conductors to give an overall thickness of 0.5 mm. The conductors are 30 mm apart with an applied voltage of 24 v. FIG. 14 shows the heating profile with time for this heater. The heater takes approximately 70 seconds to reach a maximum heat of around 45° C.
Run 10: Layers of 250 μm sandwich 4 conductors to give an overall thickness of 0.5 mm. The conductors are 30 mm apart with an applied voltage of 12 v. FIG. 15 shows the heating profile with time for this heater. The heater takes approximately 140 seconds to reach a maximum heat of around 38° C.

TABLE 2
Summary of Runs 1-10

| | Layer Thickness | Separation | | Voltage | |
|---|---|---|---|---|---|
| Run | (μm) | (mm) | Conductors | (V) | FIG. |
| 1 | 250 | 30 | 2 | 12 | 6 |
| 2 | 250 | 60 | 2 | 24 | 7 |
| 3 | 250 | 60 | 2 | 12 | 8 |
| 4 | 250 | 30 | 2 | 24 | 9 |
| 5 | 125 | 30 | 2 | 12 | 10 |
| 6 | 125 | 60 | 2 | 24 | 11 |
| 7 | 125 | 53 | 4 | 24 | 12 |
| 8 | 125 | 30 | 4 | 24 | 13 |
| 9 | 250 | 30 | 4 | 24 | 14 |
| 10 | 250 | 30 | 4 | 12 | 15 |

1. A flat sheet electrical heater comprising:
a plurality of elongate conductors evenly spaced apart from and substantially parallel to each other,
said elongate conductors being embedded within and in contact with an electrically semiconductive composition, said electrically semiconductive composition including a positive temperature coefficient and comprising a polyethylene, polypropylene, or a mixture thereof, and a conductive filler,
wherein a distance between elongate conductors is 20 to 150 mm.

2. A multilayer flat sheet electrical heater comprising, in this order:
a first layer comprising an electrically semiconductive composition with a positive temperature coefficient comprising a polyethylene, polypropylene, or a mixture thereof, and a conductive filler;
a conductor layer comprising a plurality of elongate conductors evenly spaced apart from and substantially parallel to each other wherein a distance between elongate conductors is 20 to 150 mm;
a second layer comprising an electrically semiconductive composition with a positive temperature coefficient comprising a polyethylene, polypropylene, or a mixture thereof, and a conductive filler such that said conductor layer is sandwiched between and in contact with said first and second layers.

3. The multilayer flat sheet electrical heater of claim 2, further comprising at least one additional layer above said first layer and/or at least one additional layer below said second layer.

4. The flat sheet electrical heater of claim 1, wherein the electrically semiconductive composition comprises a LDPE homopolymer or LDPE copolymer.

5. The flat sheet electrical heater of claim 1, wherein the electrically semiconductive composition comprises an ethylene alkyl acrylate or ethylene vinyl acetate polymer.

6. The flat sheet electrical heater of claim 1, wherein the conductive filler comprises carbon black.

7. The flat sheet electrical heater of claim 1, wherein the electrically semiconductive composition comprises 15-50 wt % conductive filler.

8. The multilayer flat sheet electrical heater of claim 2, wherein said first and second layers are the same.

9. The flat sheet electrical heater of claim 1, wherein the plurality of elongate conductors comprises more than 6 elongate conductors.

10. The flat sheet electrical heater of claim 1, wherein a layer formed of the semiconductive composition is 100 to 900 μm in thickness, and/or wherein the heater has a thickness of 0.25 to 20 mm.

11. The flat sheet electrical heater of claim 1, wherein when current is applied to said flat sheet electrical heater, the heater produces the same heat over the whole of the heater.

12. The flat sheet electrical heater of claim 1, wherein the flat sheet electrical heater is free of an adhesive.

13. The flat sheet electrical heater of claim 1, wherein a voltage required to heat the heater is 10 to 70 v.

14. The flat sheet electrical heater of claim 1, wherein the flat sheet electrical heater is configured to reach a maximum steady state temperature between 50 and 250 seconds after power is applied.

15. The flat sheet electrical heater of claim 14, wherein the steady state temperature is no more than 50° C.

16. The flat sheet electrical heater of claim 1 consisting of a plurality of elongate conductors evenly spaced apart from and substantially parallel to each other,
wherein said conductors are embedded within and in contact with an electrically semiconductive composition with a positive temperature coefficient comprising a polyethylene, polypropylene, or a mixture thereof, and a conductive filler wherein the distance between elongate conductors is 20 to 150 mm.

17. (canceled)

18. A process for the preparation of a multilayer flat sheet electrical heater comprising the steps of:
(a) providing and melt mixing in an extruder a first electrically semiconductive composition comprising a polyethylene, polypropylene, or a mixture thereof, and a conductive filler,
providing and melt mixing in an extruder a second electrically semiconductive composition which comprises a polyethylene, polypropylene, or a mixture thereof, and a conductive filler; and
(b) applying on a plurality of evenly spaced apart elongate conductors by coextrusion:
a meltmix of the first electrically semiconductive composition obtained from step (a), and
a meltmix of the second electrically semiconductive composition obtained from step (a), to form a multilayer flat sheet electrical heater having three layers, the three layers comprising a core layer and first and second electrically semiconductive composition layers;
wherein the core layer comprises a plurality of parallel evenly spaced apart elongate conductors embedded within and in contact with said first and second electrically semiconductive composition layers;
wherein the first and second semiconductive composition layers comprise a machine direction; and
wherein said elongate conductors are parallel to the machine direction of said first and second semiconductive layers.

19. A process of claim 18, wherein one or more additional layers is co-extruded or co-laminated outside said first or second semi conductive layer.

20. An article comprising the flat sheet electrical heater of claim 1.

21. A process for heating an article comprising applying a current to an article comprising the flat sheet electrical heater of claim 1 wherein said elongate conductors have alternate polarity.

22. (canceled)

23. (canceled)

24. A process for the preparation of a multilayer flat sheet electrical heater comprising the steps of:
(a) providing and melt mixing in an extruder a first electrically semiconductive composition comprising a polyethylene, polypropylene, or a mixture thereof, and a conductive filler,
extruding said first electrically semiconductive composition to form a first layer,
providing and melt mixing in an extruder a second electrically semiconductive composition which comprises a polyethylene, polypropylene, or a mixture thereof and a conductive filler, and
extruding said second electrically semiconductive composition to form a second layer;
(b) colaminating said first and second layers with a plurality of evenly spaced apart elongate conductors, wherein a distance between elongate conductors is 20 to 150 mm, to form a multilayer flat sheet electrical heater having three layers, the three layers comprising a core layer and first and second electrically semiconductive composition layers;
wherein the core layer comprises a plurality of evenly spaced apart elongate conductors sandwiched between and in contact with the first and second electrically semiconductive composition layers;
wherein the first and second electrically semiconductive composition layers are adhered only via a strip extending 50 to 200 cm either side of each elongate conductor.

25. The flat sheet electrical heater of claim 1,
wherein the semiconductive composition comprises a machine direction,
wherein said conductors are parallel with the machine direction of the semiconductive composition.

26. The flat sheet electrical heater of claim 1, wherein the flat sheet electrical heater is obtainable by coextrusion.
